(19) United States
(12) Patent Application Publication
(10) Pub. No.: US 2015/0015430 A1
(43) Pub. Date: Jan. 15, 2015

(54) Mobile Device Signal Interference Emitter and Control Method Thereof

(71) Applicant: Li K. Wang, Duluth, GA (US)

(72) Inventors: Li K. Wang, Duluth, GA (US); Ivy Li, Duluth, GA (US); Stephen Hsu, Duluth, GA (US)

(73) Assignee: Li K. Wang, Duluth, GA (US)

(21) Appl. No.: 13/937,639

(22) Filed: Jul. 9, 2013

(51) Int. Cl. H04K 3/00

(52) U.S. Cl. CPC H04K 3/80
USPC 342/14

(57) ABSTRACT

A radio signal jamming device for preventing mobile phone use by a driver when a vehicle is in operation includes a radio signal jammer capable of interfering with the normal operation of a mobile communication device, a controller, and a vehicular interface. The radio signal jamming device is activated when the vehicle is moving and thus preventing the mobile phone carried by the driver from sending and receiving mobile phone calls or text messages.

### FIELD OF INVENTION

The present invention relates generally to a radio signal jamming device and more specifically to a radio signal jamming device activated and controlled by the operation of a motor vehicle.

### BACKGROUND

Taking a phone call or reading a text message while driving a motor vehicle is widely considered to be one of the deadliest and most pervasive dangers on the road today. The National Highway Traffic Safety Administration (NHTSA) estimates that distracted drivers while operating a vehicle are twenty-three times more likely to crash than drivers who are not distracted. By the statistics, 3267 people were killed and an additional 416,000 were injured in crashes involving a distracted driver in the year 2010 alone. NHTSA estimated that in the year 2010, 899,000 (or 17% of total) police-reported crashes involved driver distraction. According to a study, sending or receiving a text takes a driver's eyes from the road for an average of 4.6 seconds, the equivalent—at 55 mph—of driving the length of an entire football field, blind. The Federal Motor Carrier Safety Administration's study of commercial motor vehicles (published September 2009) concluded that driver error was the predominant contributing factor in motor vehicle collisions. 39 states and the District of Columbia ban text messaging for all drivers.

Clearly then there is an urgent need to address the problem inadvertently created by the proliferation of widely-available mobile communication devices in conjunction with the operation of a multi-ton vehicle capable of traveling at dangerous speeds on public roads. Various compromises have been attempted; many mobile communication devices now feature a headset operable with minimal hand usage in an attempt to keep the driver's hands on the steering wheel of the vehicle. However, research suggests that headset usage of a communication device is not substantially safer than handheld usage. Other methods rely upon installing software in smart phones that automatically disable text or voice communication through the phone based on pre-programmed conditions. However, software is inherently limited to the device that it is installed in, and may not be present in the phone of a passenger.

Therefore, there is a need for a device to help combat the problem of driver texting and communicating through handheld devices while driving, without requiring any manual input or attention on the part of the driver while driving.

### SUMMARY

The embodiments described herein relate to a device and method for controlling a radio wave signal jammer.

In one embodiment, a radio wave signal jammer and controlling devices are disclosed. The radio wave signal jammer includes a radio signal jammer, a controller, and a speedometer interface unit. The radio signal jammer is connected to the speedometer interface unit via the controller. The controller is configured to read the speed of the motor vehicle from the speedometer interface unit. If the controller senses that the speed reported from the speedometer interface unit is above a certain threshold, it will activate the radio signal jammer if the jammer is not already on. When the controller senses that the speed reported from the speedometer interface unit is below the threshold, it will turn off the radio signal jammer if the jammer is not already off.

Additional advantages and novel features will be set forth in part in the description to follow, and in part will become apparent to those skilled in the art upon examination of the following and the accompanying drawings or may be learned by production or operation of the disclosed embodiments. The advantages of the present embodiments may be realized and attained by practice or use of various combinations of the methods, instruments, and devices set forth in the detailed description below.

### BRIEF DESCRIPTION OF DRAWINGS

Features and advantages of the claimed subject matter should become apparent upon reference to the drawings and the detailed description, wherein like numerals denote like parts. These exemplary embodiments are described in detail with reference to the drawings. These embodiments are non-limiting examples, in which like reference numerals represent similar structures throughout the multiple drawing views.

FIG. 1 illustrates is a top view of a radio signal jamming device placed under the driver seat and the related radio signal jamming zone.

FIG. 2 illustrates a top view a radio signal jamming device mounted on the steering assembly and the related radio signal jamming zone.

FIG. 3 illustrates a side view of a radio signal jammer placed underneath the driver's seat and the related radio signal jamming zone.

FIG. 4 illustrates a side view of a signal jamming device placed on the steering assembly and the related radio signal jamming zone.

FIG. 5 illustrates a schematic diagram of the radio signal jamming device according to one embodiment.

FIG. 6 illustrates a schematic diagram of the radio signal jamming device according to another embodiment.

FIG. 7 illustrates a flowchart of the operation of a radio signal jamming device.

FIG. 8 depicts a general schematic diagram of the radio signal jamming device.

### DETAILED DESCRIPTION OF DRAWINGS

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims. Numerous specific details are set forth in order to thoroughly explain the present teaching, but those of skill in the art will recognize that it is possible to practice the teaching without recourse to these specific details.

The present invention sets forth a system for a radio signal jamming device to prevent mobile device communication such as those of handheld phones.

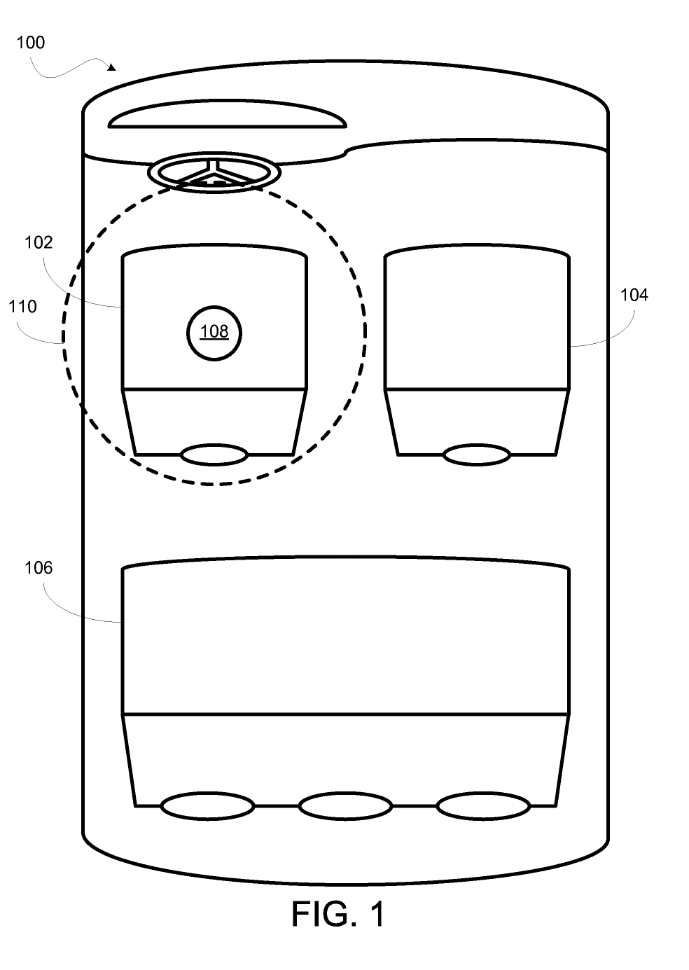

FIG. 1 illustrates a motor vehicle 100 with a radio signal jamming device 108 placed underneath the driver's seat 102 in accordance with an embodiment of the present invention. As show by the illustration, the radio signal jamming device 108 should have a power that enables extending a signal jamming field 110 in a localized sphere around the driver's seat 102. The signal jamming field 110 should preferably fall off in strength sufficiently such that the mobile devices used by the passenger 104 and the backseat 106 are unaffected.

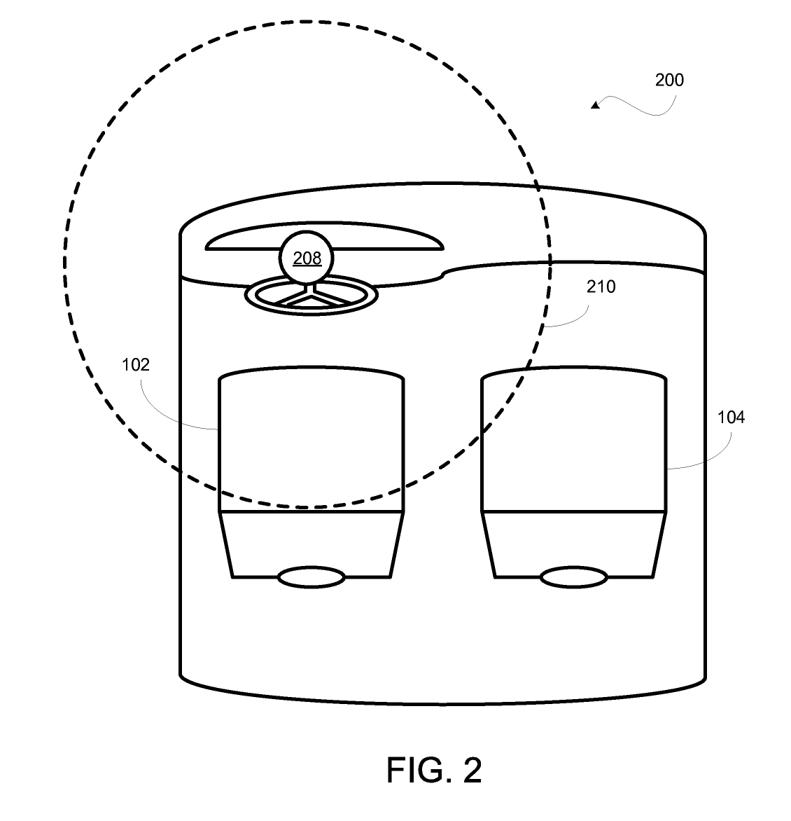

FIG. 2 illustrates a motor vehicle 200 where the radio signal jamming device 208 is placed on the steering assembly of the car. Here, the signal jamming field 210 still extends far enough to cover most of the driver's seat 102 while leaving the passenger seat 104 relatively unaffected.

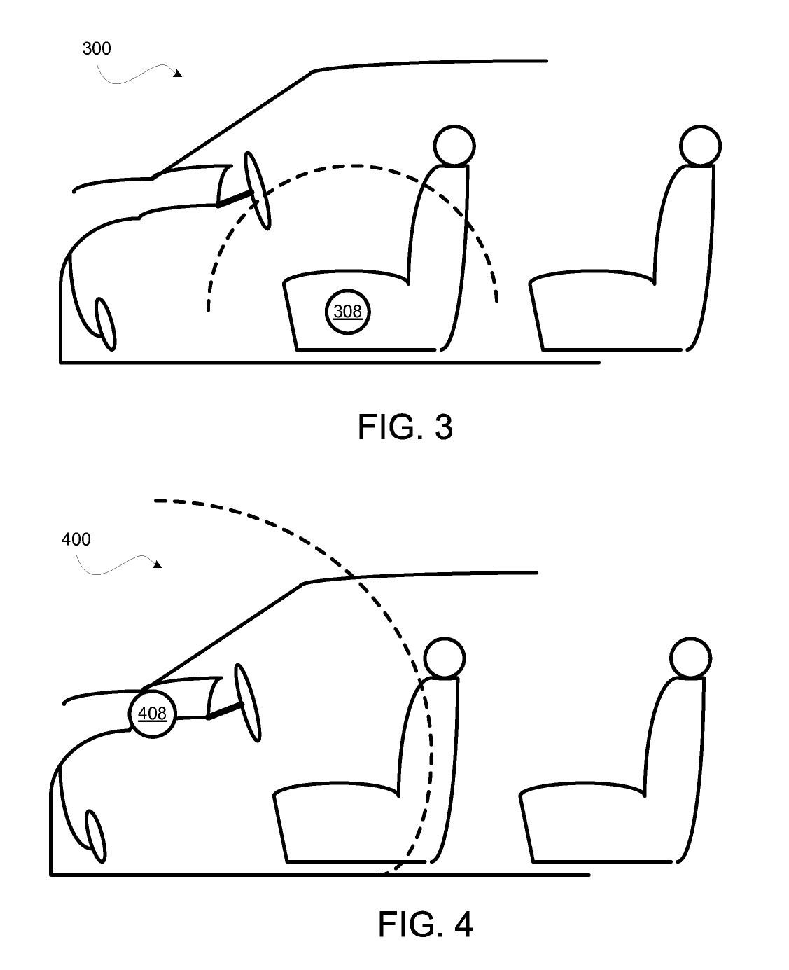

FIG. 3 illustrates a side view of the motor vehicle in FIG. 1. The radio signal jamming device 308 is placed in or beneath the driver's seat. The signal jamming field from the radio signal jamming device 308 extends far enough to block signals in the driver's vicinity while leaving the backseat unaffected.

FIG. 4 illustrates a side view of the motor vehicle in FIG. 2. The radio signal jamming device 408 is placed on the steering wheel or the dashboard of the vehicle. The signal jamming field from the radio signal jamming device 408 extends far enough to block signals in the driver's vicinity while leaving the backseat unaffected.

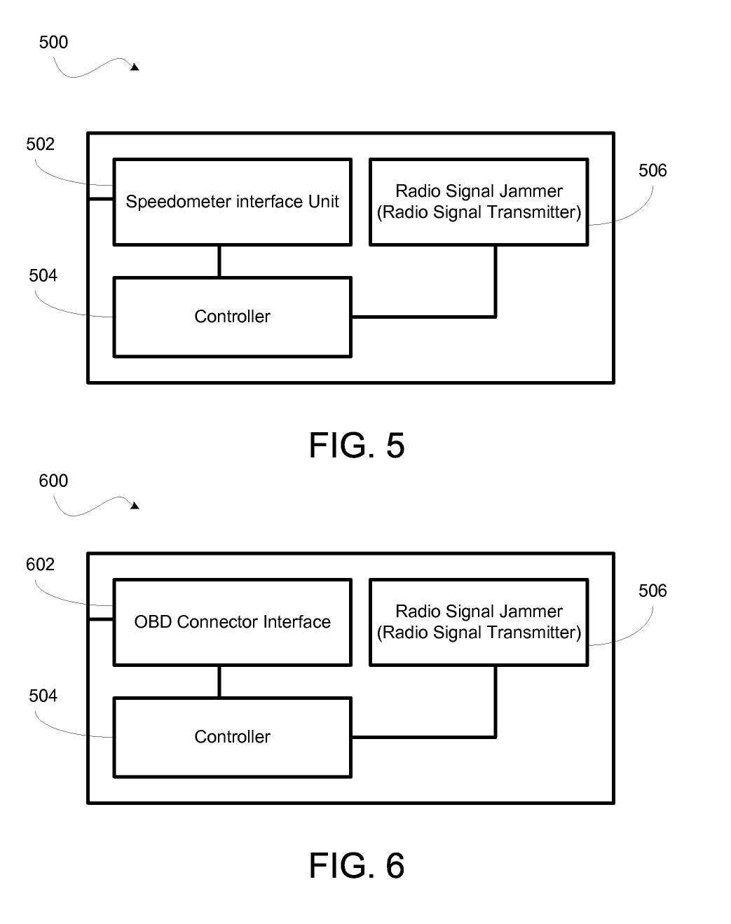

FIG. 5 illustrates a first embodiment of the schematic of the radio signal jamming device 500. The radio signal jamming device 500 is built as part of a vehicle (not shown) and the radio signal jammer (radio signal transmitter) 506 is connected to a controller 504 that reads information from a speedometer interface unit 502, in turn connected directly to the vehicle (not depicted). Upon received data from the speedometer interface unit 502, the controller 504 can activate or deactivate the radio signal jammer 506. The controller 504 will active the radio signal jammer 506 if the speed of the vehicle read by the speedometer interface unit 502 is above a select speed, for example, the speed is above 0 mph (miles per hour). In this case, as soon as the vehicle moves, the controller 504 will activate the radio signal jammer 506, thus preventing the mobile phone placed within the radio signal jamming field from sending or receiving either a voice call or a text message. The purpose of the jamming is to block out reception of radio signals and to cause a nuisance to the receiving mobile phone. The radio signal jammer 506 is basically a radio signal transmitter, tuned to the same frequency as the mobile phone and with the same type of modulation, with enough power, overrides any signal coming to the mobile phone. Alternatively the controller 504 may also be configured to adjust the signal jamming field covered by the radio signal jammer 506 by adjusting the strength of the transmitted radio signal. In yet another embodiment, the select speed for which the controller 504 activates the radio signal jammer 506 may be adjusted by the user while the vehicle is stopped and the radio frequency of radio signals may also be adjusted by the user. Adjusting the radio frequency allows the radio signal jamming device 500 to generate radio signals that block radio signals of different frequencies.

FIG. 6 illustrates a second embodiment of the schematic of the radio signal jamming device 600. The radio signal jammer 506 is connected to a controller 504 which reads information from an onboard diagnostic (OBD) connector interface 602. Here the controller 504 is supplied with data from the OBD connector interface 602, which may provide information such as current location, speed, or the state of the vehicle. The radio signal jamming device 600 may be a device that connects to the OBD connector of an automobile. Though FIGS. 5 and 6 show two different devices, those skilled in the art will appreciate that different configurations or combinations may be obtained from the concept disclosed herein. For example, the speedometer interface unit 502 may obtain the current speed of the automobile through the OBD connector interface 602.

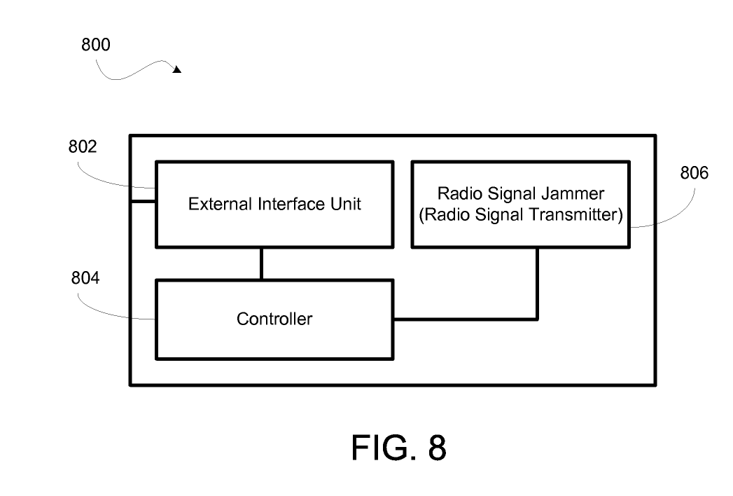

The radio signal jamming device may be configured to respond to certain environment conditions other than vehicle's speed. FIG. 8 illustrates a generalization of embodiments shown in FIGS. 5 and 6. The radio signal jamming device 800 has an external interface unit 802 that interfaces with other components of the vehicle. In the embodiments shown in FIGS. 5 and 6, the external interface unit 802 is respectively a speedometer interface unit 502 and an OBD connector interface. In the embodiment of FIG. 8, the external interface unit 802 may receive the time information from a clock unit (not shown) in the vehicle, and the controller 804 will activate the radio signal jammer 806 when the controller 504 interprets the time as rush hour. The external interface unit 802 may also receive position information of the vehicle from the global positioning system (GPS) from a GPS unit on the vehicle. If the controller 804 determines that the vehicle is in a high-risk zone (e.g., a school zone, a construction site, or an area with known propensity for vehicular incidents), the controller 804 may activate the radio signal jammer 806 until the controller 804 determines that the vehicle has exited the high-risk zone. The external interface unit 802 may receive weather related information from the vehicle. For example, the external interface unit 802 may receive information that the windshield wiper is active and this information implies that the vehicle may be riding in a rainy condition. Based on this weather related information, the controller 804 will activate the radio signal jammer 806 because external conditions are hazardous. A low external temperature indication with the raining indicator received from the vehicle may indicate that the possibility of an icy road condition is great, so the controller 804 may activate the radio signal jammer 806.

The vehicle may offer a user interface for a user to set or adjust the conditions at which the radio signal jammer is turned on. The user may adjust the outside temperature when the radio signal jammer should turn on when it is raining; the user may adjust the starting time and ending time for the rush hour, i.e., whether the rush hour starts at 3 PM or 4 PM and ends at 6 PM or 7 PM. The user may also adjust at what speed the radio signal jammer is to turn on and wireless communication is no longer allowed. The conditions set by the user are compared later with the environment information received from the automobile and if the environment conditions match the conditions set by the user, the radio signal jamming device will start the operation.

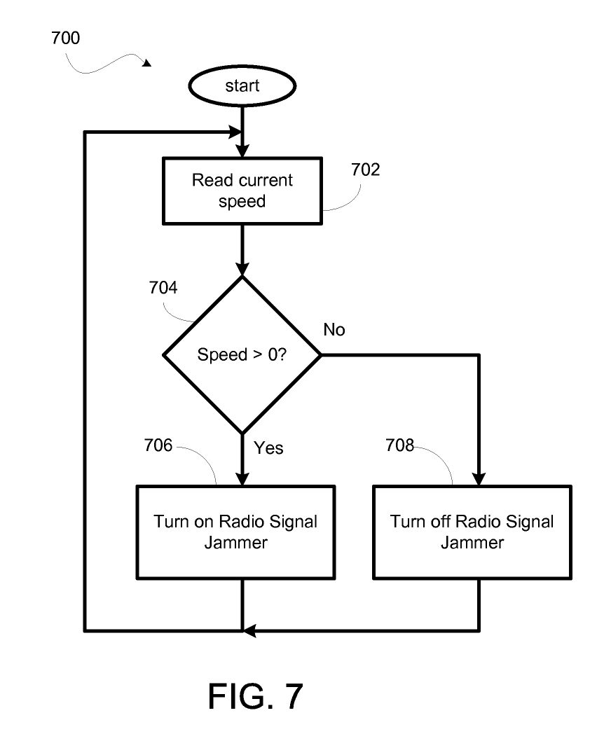

FIG. 7 illustrates a flowchart for the operation of the first embodiment of the radio signal jamming device. The controller 504 reads the current speed, step 702, from the speedometer interface unit 502. The controller 504 determines if the speed is above zero, step 704. The controller 504 may be configured to respond to a variety of road conditions in addition to or besides the speed of the vehicle. If the controller 504 detects that the vehicle is moving, then the radio signal jammer 506 is activated or kept on, step 706. If the controller 504 detects that the vehicle is not moving, then the radio signal jammer 506 is turned off or kept off (step 708). The process then repeats. The speed for which the radio signal jammer 506 is turned on may be adjusted by the user while the automobile is not moving. The controller 504 may be configured to monitor the vehicle continuously; alternatively, the controller 504 may be configured to monitor the vehicle at set intervals of time or distance. For example, the controller may be configured to check the state of the vehicle from the speedometer interface unit 502 or the OBD connector 602 every half minute or every half-mile of distance.

Though the description for FIG. 7 uses the speed of the vehicle as the criterion whether to turn on the radio signal jammer 506, it is understood that other criteria listed above in regard with the description of FIG. 8 may be used, i.e., the radio signal jammer may be turned on if the vehicle in moving during the rush hour or in a school zone.

In operation, a user may set up the speed at which the radio signal jamming device is to turn on before allowing his daughter to use his car. The user may set up the speed to be 5 mph, i.e., when the his car is moving at or above 5 mph, the radio signal jammer in the radio signal jamming device will turn on and start to emitting radio signals that make reception of wireless signal impossible around the driver position. When his daughter drives the car out of the garage and onto the road, the radio signal jamming device will start working and his daughter will no longer be able to make calls or receive text messages on her mobile phone. If his daughter wants to call home, she has to stop the car or slow the car to less than 5 mph before her mobile phone can receive wireless signals.

While the foregoing description and drawings represent embodiments of the present teaching, it will be understood that various additions, modifications, and substitutions may be made therein without departing from the spirit and scope of the present teaching as defined in the accompanying claims. One of skill in the art will appreciate that the teaching may be used with many modifications of form, structure, arrangement, proportions, materials, elements, and components and otherwise without departing from the principles of the present teaching. The presently disclosed embodiments are therefore to be considered in all respects as illustrative and not restrictive, the scope of the teaching being indicated by the appended claims and their legal equivalents, and not limited to the foregoing description.

What is claimed is:

1. A radio signal jamming device for a motor vehicle, comprising:
a radio signal transmitter capable of transmitting radio signals of selected frequencies;
a speedometer interface unit for receiving a current speed of the motor vehicle; and
a controller for receiving the current speed from the speedometer interface unit and activating the radio signal transmitter based on the current speed.

2. The radio signal jamming device of claim 1, wherein the controller activates the radio signal transmitter when the current speed is above a select speed.

3. The radio signal jamming device of claim 1, further comprising an onboard diagnostic (OBD) connector interface, wherein the speedometer interface unit obtains the current speed through the OBD connector interface.

4. A method, for operating a radio signal jamming device for a motor vehicle, comprising the steps of:
reading a current speed of the motor vehicle;
determining, by a controller, if the current speed is greater than a select speed; and
if the current speed is greater than the select speed, activating a radio signal transmitter, by the controller; and
transmitting, by the radio signal transmitter, radio signals

5. The method of claim 4, further comprising the step of deactivating the radio signal transmitter, by the controller, if the current speed is below than the select speed.

6. The method of claim 4, further comprising the step of adjusting the select speed while the motor vehicle is stopped.

7. The method of claim 5, further comprising the step of adjusting a radio frequency for the radio signals while the motor vehicle is stopped.

8. A method, for operating a radio signal jamming device for a motor vehicle, comprising the steps of:
receiving, through an external interface unit, environment information;
comparing the environment information with a set of predefined conditions;
if the environment information match the set of predefined conditions, turning on a radio signal jammer; and
emitting, by the radio signal jammer, radio signals.

9. The method of claim 8, further comprising the step of receiving the set of predefined conditions through the external interface, wherein the set of predefined conditions being defined by a user.

10. The method of claim 8, wherein the environment information comprises outside temperature.

11. The method of claim 8, wherein the environment information comprises global positioning system (GPS) coordinates.

12. The method of claim 8, wherein the set of predefined conditions comprises school zone information.
